(19) United States
(12) Patent Application Publication
(10) Pub. No.: US 2025/0297859 A1
(43) Pub. Date: Sep. 25, 2025

(54) Gyroscopic measurement method and sensor

(71) Applicant: THALES, Meudon (FR)

(72) Inventors: Nicolas Jean-Marc Frédéric VERCIER, VALENCE CEDEX (FR); Nicolas Paul MARTIN, VALENCE CEDEX (FR)

(21) Appl. No.: 18/788,336

(22) Filed: Jul. 30, 2024

(30) Foreign Application Priority Data
Mar. 25, 2024 (FR) 2402963

(51) Int. Cl. G01C 19/5776

(52) U.S. Cl. CPC G01C 19/5776

(57) ABSTRACT

The present invention relates to a method (400) of gyroscopic measurement by means of a sensor (10) comprising a housing (12) and a vibrating element (15) apt to vibrate relative to the housing (12) comprising supplying a first servo module (20) with a first force (Fₓ) to be exerted along the direction of the pilot mode (x) on the vibrating element (15), and a pilot amplitude (xₘₐₓ) for servoing the vibrations along the direction of the pilot mode (x); the simultaneous use of the first force (Fₓ) and of the servoing of the vibrating element (15) along the direction (x) of the pilot mode; the supply to a second servo module (25) of a second force (F_{y}) to be exerted in phase quadrature with the first force along the direction of the detection mode (y), and a non-zero vibration servo amplitude (yₘₐₓ) along the direction (y) of the detection mode; the simultaneous use of the second force (F_{y}) and of the servoing along the direction (y) of the detection mode; and the determination of an instantaneous angular speed (Ω(t)) of the housing in an inertial frame of reference.

### BACKGROUND OF THE DISCLOSURE

### Field of the Disclosure

The present invention relates to a gyroscopic measurement method.

The invention further relates to a gyroscopic sensor for implementing the gyroscopic measurement method, as well as to a computer program comprising instructions which lead the sensor to execute the step of determining the instantaneous angular speed of the gyroscopic sensor of the method.

### Description of Related Art

A Coriolis Vibratory Gyroscope (CVG) sensor makes it possible to measure the component along an axis, called the axis of sensitivity, of an instantaneous speed of rotation vector of a frame of reference attached to a sensor housing with respect to an inertial frame of reference.

For this purpose, the CVG comprises a vibrating element of the sensor, apt to vibrate with respect to the housing. The measurement can be made due to the effects of the Coriolis inertial force exerted on the vibrating element.

The vibrating element of a CVG is apt to vibrate in two coplanar vibration directions, called pilot mode direction and detection mode direction, the work of the Coriolis force making possible a transfer of mechanical energy between the two directions.

The axis of sensitivity of the CVG is orthogonal to the plane of the directions of the pilot mode and of the detection mode.

For the measurements, the vibrating element is excited by the excitation system, along the direction of the pilot mode at the resonant frequency. The amplitude of the vibrations according to the pilot mode is kept constant by means of a servo system by means of which the voltage applied to the excitation system is controlled. Any variations in the resonant frequency, in particular related to variations in the temperature of the vibrating element, are monitored by means of a frequency control system.

If the component along the axis of sensitivity of the instantaneous speed of rotation vector of the housing with respect to an inertial frame of reference is non-zero, the displacement of the vibrating element along the direction of the pilot mode generates a Coriolis force. Said force excites the vibrating element along the direction of the detection mode, at an amplitude which is proportional to the component along the axis of sensitivity of the instantaneous speed of rotation vector.

A CVG can operate in two modes: the gyroscope mode and the gyrometer mode.

In the gyroscope mode, the position of the pilot mode direction in the vibratory plane is free. The instantaneous speed of rotation to be measured is then deduced from the angular position of the vibration plane of the vibrating element in the frame of reference attached to the housing.

In the gyrometer mode, the direction of the pilot mode in the vibration plane is servoed by sending an electronic command and the instantaneous speed of rotation to be measured is deduced from the force to be exerted to control this direction.

Whether the CVG is used in the gyroscopic mode or in the gyrometer mode, the measurements are subject to intrinsic errors related to the defects of the CVG. The defects include the stiffness or damping anisotropies of the vibrating element, the defects of the control electronic components of the excitation or of the detection electronic components of the position of the vibrating element, the defects of the electrical reference voltage for the excitation, etc.

Among the errors, some are called harmonic errors because they are proportional to cosine or sine functions of an even multiple angle of the angle characterizing the position of the directions of the pilot mode of the detection mode in the frame of reference attached to the housing.

U.S. Pat. No. 6,598,455 describes a gyroscopic measurement method wherein the geometrical vibration position of the gyroscope is modified voluntarily by electrostatic means over time, in order to improve the calibration of the gyroscope.

U.S. Pat. No. 7,093,370 describes, moreover, a MEMS gyrometer wherein an angular speed is deliberately imposed on the sensor by mechanical means. the direction of rotation of the sensor being periodically alternated in order to reduce measurement errors and in particular scale factors errors of the gyrometer.

FR 2937414 describes a vibrating gyroscope that combines the principles of U.S. Pat. No. 6,598,455, by injecting an electronic signal to rotate the vibration wave, and of U.S. Pat. No. 7,093,370, by imposing a periodically alternating electrical rotation for minimizing harmonic errors. The command signal is suitable for rotating the geometrical vibration position of the gyroscope in a first direction during a part of the period of the command signal according to a first speed profile and then in an opposite direction according to a second speed profile. The vibrating gyroscope then provides a corrected signal which is based on the difference between the measurement signal and the command signal.

However, due to errors in the conversion chain of the command signal into electrostatic force, the force actually applied to the vibrating element of the gyroscope to obtain the alternating rotation thereof is different from the force that should theoretically be obtained from the command signal.

If the errors of the conversion chain are perfectly stable over time, the error made on the angle measurement can be zero over a period characteristic of the variations of the command signal.

However, this is very unlikely, as the sources of error are many and of different kinds. The errors include detection errors of the detection combs, excitation errors of the excitation combs and instabilities of the reference voltage used for the operation of the combs, and errors in the electronic boards that coordinate the implementation of the gyroscopic measurement method.

Ultimately, in most situations, the mean value of the error committed is not zero over a period of the alternating rotation of the sensor position. Moreover, during the round trip of the wave, the angular errors of the sensor are all the greater the more significant the above-mentioned defects.

Such a device reduces the impact of defects on the measurement without making it possible to evaluate the measurement error related to these defects.

Furthermore, the command signal used in FR 2937414 should be used to return to the same angular position between the beginning and the end of the control period. In cases where the gyroscope is moving in the inertial frame of reference and not at rest in the frame of reference, such a signal cannot serve to both obtain a zero mean command signal and to return to the same angular position.

### BRIEF SUMMARY OF THE DISCLOSURE

An aim of the invention is then to propose a gyroscopic measurement method making it possible to estimate measurement errors, in particular harmonic anisotropy errors, in order to take these errors into account in the result of the measurement, and thereby to obtain a measurement result of known or even improved precision, regardless of the nature of the sensor movement in an inertial frame of reference.

To this end, the subject matter of the invention is a gyroscopic measurement method by means of a sensor comprising a housing and a vibrating element apt to vibrate relative to the housing in a vibration plane simultaneously along a direction of a pilot mode and along a direction of a detection mode different from the direction of the pilot mode, the method comprising:
the supply to a first servo module of the sensor:
a) of a first amplitude of a first force to be exerted along the direction of the pilot mode on the vibrating element, and
b) of a predetermined non-zero pilot amplitude to which an amplitude characteristic of forced sinusoidal vibrations of the vibrating element in the direction of the pilot mode is to be servoed; and
   simultaneously, the application of the first force on the vibrating element and the servoing of the amplitude characteristic of the forced sinusoidal vibrations of the vibrating element along the direction of the pilot mode by means of the first servo module receiving measurements of the vibrations of the element vibrating along the direction of the pilot mode from a measurement module measuring the vibrations of the vibrating element;
the method being characterized in that the method further comprises:
   the supply to a second servo module:
c) of a second amplitude of a second force to be exerted in phase quadrature with the first force along the direction of the detection mode, and
d) of a predetermined non-zero detection amplitude to which an amplitude characteristic of the vibrations of the vibrating element along the direction of the detection mode is to be servoed; and
   simultaneously, the application of the second force on the vibrating element and the servoing of the amplitude characteristic of the vibrations of the vibrating element along the direction of the detection mode by means of the second servo module receiving measurements of a position of the vibrating element along the direction of the detection mode from the measurement module; and
   the determination, by means of a determination module of the sensor, of an instantaneous angular speed of the housing in an inertial frame of reference from the first and second amplitudes of the first and second forces, from the non-zero pilot and detection amplitudes, as well as from the measurements of the vibrations of the vibrating element transmitted by the measurement module to the first and second servo modules.

The vibrating element is excited both along the direction of the pilot mode and along the direction of the detection mode, not only under the effect of the two forces of predetermined amplitudes but also of the servoing.

The vibrating element oscillates with a non-zero amplitude along the direction of the pilot mode as in the methods of the prior art. Unusually, the vibrating element also oscillates with a non-zero amplitude along the direction of the detection mode.

The servoing of the amplitude of the vibrations according to the detection mode to a non-zero value is carried out by applying a force along the direction of the detection mode the evaluation of which is used, in combination with the evaluation of the force actually implemented to perform the servoing of the amplitude of the vibrations according to the pilot mode, to estimate the anisotropy errors of damping of the vibrating element. The estimated errors can then be taken into account quantitatively in the step of determining the angular speed of the housing. Thereby, the precision of the gyroscopic measurement is improved compared to the methods of the prior art, wherein the errors are minimized without being evaluated.

According to other advantageous aspects of the invention, the method of measurement comprises one or a plurality of the following features, taken individually or according to all technically possible combinations:
the ratio between the pilot amplitude and the detection amplitude is less than 100;
the vibrations of the vibrating element are characterized by an angular frequency different from the natural angular frequency of the vibrating element, the relative difference between the angular frequency and the natural angular frequency being less than 10%, preferably on the order of 1% or less;
the method further comprises a step of determining a characteristic angular frequency of the vibrations of the vibrating element by means of the determination module, on the basis of the measurements of the positions of the vibrating element transmitted by the measurement module to the first and second servo modules.
the application of the first force and of the second force on the vibrating element comprises a step of determining a matrix characteristic of an anisotropy of the vibrating element from an amplitude of a third force and from an amplitude of a fourth force actually exerted by the first servo module and the second servo module, respectively, to servo the characteristic amplitude of the vibrations of the vibrating element along the direction of the pilot mode and the characteristic amplitude of the vibrations of the vibrating element along the direction of the detection mode, respectively.

The invention further relates to a gyroscopic sensor comprising:
a housing;
a vibrating element apt to vibrate relative to the housing along a vibration plane simultaneously along a direction of a pilot mode and along a direction of a detection mode different from the direction of the pilot mode;
a measurement module, apt to generate measurements of vibrations of the vibrating element along the directions of the pilot mode and of the detection mode;
a first servo module apt to:
i) exert a first force, the amplitude of which is equal to a first predetermined amplitude, on the vibrating element along the direction of the pilot mode, and
ii) simultaneously, servo a characteristic amplitude of forced sinusoidal vibrations of the vibrating element along the direction of the pilot mode to a predetermined non-zero pilot amplitude,
iii) receive measurements of the vibrations of the vibrating element along the direction of the pilot mode from the measurement module to carry out the servoing;
the sensor being characterized in that the sensor comprises:
   a second servo module apt to:
iv) exert a second force, the amplitude of which is equal to a second predetermined amplitude, on the vibrating element along the direction of the detection mode, the second force being in phase quadrature with the first force, and
v) simultaneously, servo a characteristic amplitude of the vibrations of the vibrating element along the direction of the detection mode, to a non-zero detection amplitude,
vi) receive measurements of the vibrations of the vibrating element along the direction of the detection mode from the measurement module to perform the servoing;
   a determination module apt to determine an instantaneous angular speed of the housing in an inertial frame of reference from the amplitudes of the first force and the second force, from the non-zero pilot amplitude and the non-zero detection amplitude, as well as from the measurements of the vibrations of the vibrating element transmitted by the measurement module to the first and second servo modules.

The invention further relates to a computer program comprising instructions which cause the sensor as described hereinabove to execute the step of determining the instantaneous angular speed of the casing of the method according to any of the preceding embodiments.

### BRIEF DESCRIPTION OF THE SEVERAL VIEWS OF THE DRAWING(S)

The invention will be clearer upon reading the following description, given only as an example, but not limited to, and making reference to the drawings wherein:

FIG. 1 is a schematic representation of a CVG according to the invention;

FIG. 2 part A is a schematic representation of the operation of the CVG of the prior art; FIG. 2 part B is a schematic representation of the operation of the CVG shown in FIG. 1;

FIG. 3 is a schematic representation of the trajectory of the vibrating element of FIG. 1 and of the directions of the pilot and detection modes thereof in a space coordinate frame attached to the housing;

FIG. 4 is a flowchart representation of an embodiment of a method according to the invention.

### DETAILED DESCRIPTION OF THE DISCLOSURE

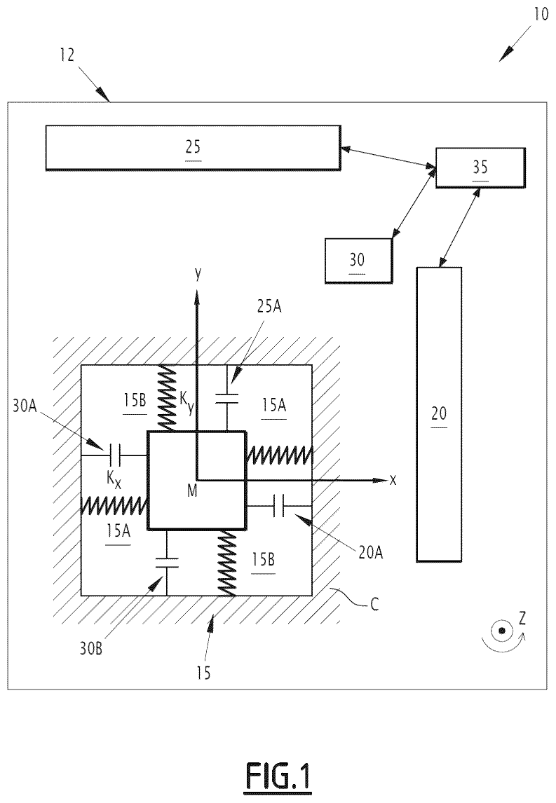

The gyroscopic Coriolis effect sensor 10, referred to by the abbreviation CVG hereinafter, according to the invention is described with reference to FIG. 1.

The CVG 10 includes a housing 12 and a vibrating element 15 apt to vibrate with respect to the housing 12.

The CVG 10 is e.g. produced in the form of a micro electromechanical sensor (MEMS) system. The vibrating element 15 and the casing 12 are then cut from a silicon or quartz block by micromachining and the vibrating element 15 is vibrated using an electrical method Such arrangement makes it possible to minimize the overall size and/or the manufacturing cost of the CVG 10.

Three axes X, Y, Z of the space coordinate frame XYZ of a frame of reference attached to the housing 12 are shown in FIG. 1, the axis Z being of fixed direction in a space coordinate frame of an inertial frame of reference.

The CVG 10 is configured to measure an instantaneous angular speed Ω of the sensor relative to the axis Z, which is thus the axis of sensitivity of the CVG 10.

To this end, the vibrating element 15 is apt to vibrate in the plane XY along two directions x and y, with a natural angular frequency ω, respectively ω.

Hereinafter, it is considered that the direction x is the direction of the pilot mode and that the direction y is the direction of the detection mode.

The CVG 10 includes a first servo module 20 apt to servo a characteristic amplitude of vibrations of the vibrating element 15 to a predetermined non-zero pilot amplitude xₘₐₓ, the vibrating element 15 vibrating in a sinusoidal regime forced at the angular frequency ω along the direction x of the pilot mode, from measurement data of the position of the vibrating element in the direction x of the pilot mode.

The first servo module 20 comprises usual means for servoing the amplitude of the vibrations of the vibrating element 15 according to the pilot mode. Said means are not shown in detail in the figures. Same are e.g. the control means described in document EP2960625.

As an example, which will be referred to hereinafter as the reference example, the first servo module 20 comprises an electrostatic device 20A configured to exert in the vibrating element 15 a first force F_{x,amp} having the direction x of the pilot mode. The first force F_{x,amp} is then proportional to a first amplitude control.

The first servo module 20 comprises in the reference example a processor or a programmable logic circuit (such as a Field Programmable Gate Array, FPGA), configured to manage the servoing of the first amplitude control, as well as a proximity board configured to inject the first amplitude control signal into the electrostatic device 20A.

The first servo module 20 is apt to receive a first predetermined amplitude F_{x,max} of a second force Fₓ and to exert the second force on the vibrating element 15 along the direction x of the pilot mode.

In the example described hereinabove, the electrostatic device 20A is configured so as to exert the second force Fₓ having the direction x of the pilot mode and the amplitude F_{x,max}. The second force Fₓ is then proportional to a stiffness command, which is sent by the processor or the programmable logic circuit and injected into the electrostatic device 20A by means of the proximity board.

The processor or the programmable logic circuit is advantageously configured to manage the servoing of the angular frequency of the vibrations of the vibrating element 15 along the direction x of the pilot mode.

As will be seen further down, the second force Fₓ, of predetermined amplitude F_{x,max}, is different from the first force F_{x,amp}, which is intended to go against the damping of the vibrations of the vibrating element 15 along the direction x of the pilot mode in order to maintain constant the amplitude of the vibrations along the direction x of the pilot mode.

The first servo module 20 is thus configured to exert on the vibrating element 15 a total force F_{tot,x} along the direction x of the pilot mode which is the resultant of the first force F_{x,amp} and of the second force Fₓ, the servoing of the amplitude of the vibrations of the vibrating element 15 along the direction x of the pilot mode being carried out in the presence of the second force Fₓ.

The CVG 10 includes second control module 25 apt to control a characteristic amplitude of vibrations of the vibrating element 15 along the direction Y of the detection mode to a non-zero detection amplitude yₘₐₓ, the vibrating element 15 vibrating in a forced sinusoidal regime along the direction y of the detection mode at an angular frequency ω, from measurement data of the position of the vibrating element along the direction y of the detection mode.

To this end, the second servo module 25 may comprise servo means similar to the servo means of the first servo module 20 (not shown in detail).

Thereby, in the reference example, the second servo module 25 comprises an electrostatic device 25A configured to exert on the vibrating element 15 a third force F_{y,amp} having the direction x of the detection mode. The third force F_{y,amp} is then proportional to a first amplitude control.

The second servo module 25 comprises, in the reference example, a processor or a programmable logic circuit (Field Programmable Gate Array, FPGA) configured to manage the servoing of the second amplitude control. The second servo module 25 further comprises a proximity board configured to inject the second amplitude control signal into the electrostatic device 25A.

The processor or the programmable logic circuit (such as a Field Programmable Gate Array, FPGA) is in the reference example the same as the one of the first servo module 20. Such arrangement is advantageous without being mandatory.

The processor or the programmable logic circuit is advantageously configured to manage the control of the angular frequency of the vibrations of the vibrating element 15 along the direction y of the detection mode.

In the reference example, the proximity board is the same as the proximity board of the first servo module 20. Such arrangement is advantageous without being mandatory.

The third force F_{y,amp} is intended to maintain the amplitude of the vibrations along the direction y of the detection mode equal to the non-zero detection amplitude yₘₐₓ. It is thus different from the force exerted in the prior art depending on the detection mode, e.g. by means of a quadrature command sent to the electrostatic device 25A in order to cancel out the amplitude of the vibrations depending on the detection mode.

The second servo module 25 is apt to receive a second amplitude F_{y,max} of a fourth force F_{y} to be exerted on the vibrating element 15 along the direction y of the detection mode.

In the reference example, the electrostatic device 25A is thereby configured to exert a fourth force F_{y} having the direction y of the detection mode and the amplitude equal to the second amplitude F_{y,max}. The fourth force F_{y} is then proportional to a precession command, which is sent by the processor or the FPGA and injected into the electrostatic device 25A by means of the proximity board.

As will be seen later, the fourth force F_{y}, of predetermined amplitude F_{y,max}, is different from the third force F_{y,amp}, which is intended to go against the damping of the vibrations of the vibrating element 15 along the direction y of the detection mode in order to maintain the amplitude of the vibrations constant along the direction y of the detection mode.

The second servo module 25 is thus configured to exert on the vibrating element 15 a total force F_{tot,y} along the direction y of the pilot mode which is the resultant of the third force F_{y,amp} and of the fourth force F_{y}, the servoing of the amplitude of the vibrations along the direction y of the detection mode being thereby carried out in the presence of the third force.

The CVG 10 comprises a measurement module 30 apt to generate measurements of the vibrations of the vibrating element 15 along the directions x of the pilot mode and y of the detection mode and apt to exchange data with the first servo module 20 and with the second servo module 25.

In particular, the measurement module 30 is apt to measure the position x(t) (y(t), respectively) of the vibrating element 15 and/or the speed dx/dt(t) (dy/dt(t), respectively) and/or the acceleration d²x/dt²(t) (d²y/dt²(t), respectively along the direction x (along the direction y, respectively).

To this end, the measurement module 30 comprises, in the reference example, but not limited to, electrostatic means of detection 30A along the direction x of the pilot mode and electrostatic detection means 30B along the direction y of the detection mode.

In the reference example, the proximity board is advantageously configured to amplify the signals detected by the measurement module 30 and to transmit the amplified signals to the processor or to the programmable logic circuit.

The measurement module 30 is also configured to exchange data with a determination module 35 of the CVG 10.

The determination module 35 apt to exchange data not only with the measurement module 30 but also with the first and second servo modules 20, 25.

The determination module 35 is apt to determine an instantaneous angular speed Ω(t) of the housing 12 at a date t in the inertial frame of reference from:
the measurements of the vibrations of the vibrating element 15 generated by the measurement module 30,
the first amplitude F_{x,max},
the second amplitude F_{y,max},
the non-zero pilot amplitude xₘₐₓ,
and the non-zero detection amplitude yₘₐₓ.

Advantageously, the determination module 35 is apt to determine an angular frequency ω characteristic of the vibrations of the vibrating element 15 according to the pilot mode and/or according to the detection mode, respectively.

The CVG 10 operates as a gyroscopic sensor insofar as the instantaneous angular speed Ω(t) of the housing 12 is determined by the determination module 35.

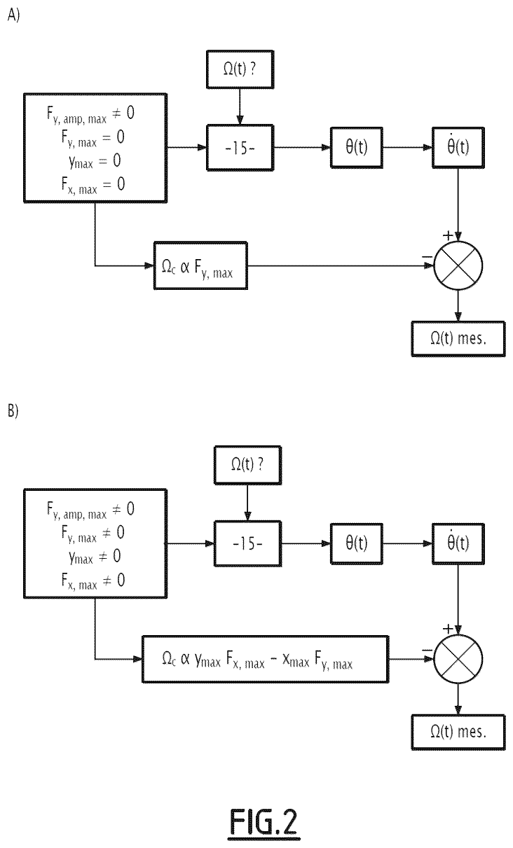

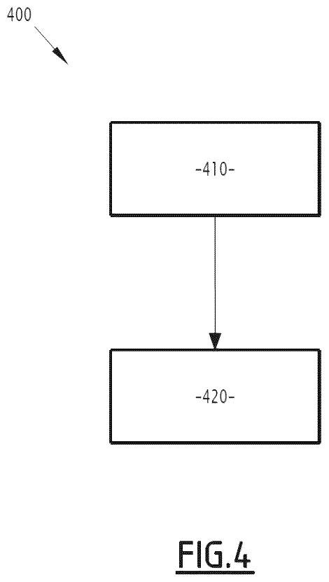

The gyroscopic measurement method 400 implemented by means of the CVG 10 will now be described with reference to FIG. 2, part B, and to FIG. 4.

In order to simplify the writing of the equations making it possible to understand the method, the vibrating element 15 is modeled hereinafter by a mass M suspended on a rigid frame C by means of two pairs of springs 15A, 15B of respective stiffnesses Kₓ and K_{y}, as shown in FIG. 1

Moreover, it is considered hereinafter that the stiffness constants and the natural angular frequencies of the vibrating element 15 are identical according to the pilot mode x and the mode y. In such particular case, it can thus be written that Kₓ=K_{y}=K and that ω₀ₓ=ω_{0y}=ω₀.

Such simplification should in no case be considered limiting for the operation of the sensor according to the invention, since the following equations can be rewritten without any difficulty in the most general case.

The method 400 comprises:
a forcing step 410 comprising the simultaneous application of the second force Fₓ by means of the first servo module 20 and of the fourth force F_{y} by means of the second servo module 25, the amplitudes of the vibrations of the vibrating element being simultaneously servoed to the non-zero pilot amplitude xₘₐₓ and to the non-zero detection amplitude yₘₐₓ, respectively,
followed by a determination step 420 of determining the instantaneous angular speed Ω(t) of the housing 12 in the inertial frame of reference.

In the forcing step 410, the mass M is excited so as to vibrate in a forced sinusoidal mode at the angular frequency ω along the direction x with the non-zero amplitude xₘₐₓ, while the second force Fₓ is exerted on the mass M along the direction x of the pilot mode.

For this purpose, the first servo module 20 receives measurements from the module 30 of the vibrations of the mass M along the direction x of the pilot mode and exerts the first force F_{x,amp}.

The first servo module 20 thereby simultaneously exerts the second force Fₓ and the first force F_{x,amp} which is configured to keep constant the amplitude of the vibrations of the vibrating element 15 along the direction x.

The first and second forces are in phase quadrature with each other and have the angular frequency ω.

During the forcing step 410, the vibrating element 15 is therefore subjected along the direction x, by means of the first servo module 20, to the force F_{tot,x}, which is the resultant of the second force Fₓ and of the first force F_{x,amp}.

Simultaneously, the mass M is excited to vibrate in a forced sinusoidal regime at the angular frequency ω along the direction y of the detection mode, with the non-zero amplitude yₘₐₓ and in phase quadrature with the oscillations along the direction x of the pilot mode, while the fourth force F is exerted on the vibrating element 15.

To this end, the second servo module 25 receives measurements from the module 30 of the vibrations of the mass M along the direction y of the detection mode, and same exerts the third force F_{y,amp} on the mass M. The third force F_{y,amp} has the direction y of the detection mode and is in phase quadrature with the first force F_{x,amp}.

The second servo module 25 thereby simultaneously exerts the fourth force F_{y} and the third force F_{y,amp} configured to keep the amplitude of the vibrations of the vibrating element 15 constant along the direction y.

The third and fourth forces F_{y,amp} and F_{y} are in quadrature with each other, and the fourth force is in phase quadrature with the second force Fₓ.

During the forcing step 410, the vibrating element 15 is thus subjected along the direction y, by means of the second servo module 25, to the force F_{tot,y}, which is the resultant of the fourth force F_{y} and of the third force F_{y,amp}.

During the forcing step 410, the mass M is thus excited by means of the first servo module 20 and of the second servo module 25 so as to vibrate in a sinusoidal regime forced at the angular frequency ω along the direction x with the non-zero amplitude xₘₐₓ as in the methods of the prior art, as well as, along the direction y with the non-zero amplitude yₘₐₓ, unlike the sensors of the prior art wherein the vibrating element 15 is not subjected to any forced excitation according to the detection mode y, at the same angular frequency ω as in the pilot mode but in phase quadrature.

In the method 400, the mass M is thus simultaneously excited along the direction x by a second force of the form Fₓ=F_{x,max} cos (ωt) and along the direction y by a fourth force in quadrature, of the form F_{y}=F_{y,max} sin (ωt) in addition to the first force F_{x,amp} and the third force F_{y,amp} intended to servo the amplitudes of the vibrations according to the pilot and detection modes.

It will be shown later that during the forcing step 410, because of the presence of the second force Fₓ and of the fourth force F_{y}, the vibrating element 15 vibrates at an angular frequency ω different but close to the specific angular frequency ω₀.

If, in a step prior to the forcing step 410, the vibrating element is excited to the natural angular frequency ω₀ thereof in the absence of a second force, the amplitude of the vibrations according to the detection mode being servoed to a value equal to zero, a shift of the angular frequency of the vibrations from the natural angular frequency ω₀ to the angular frequency ω will occur spontaneously during a transient phase at the beginning of the forcing step 410.

During the determination step 420, the determination module 35 determines the instantaneous angular speed Ω(t) relative to the inertial frame of reference.

For this purpose, the determination module 35 receives:
results of the measurements the vibration of the vibrating element 15, from the measurement module 30,
the amplitude F_{x,max} of the first force and the amplitude F_{y,max} of the second force,
as well as the amplitudes xₘₐₓ and yₘₐₓ.

The processor of the determination module 35 then implements a model for determining the instantaneous angular speed Ω(t) to determine the angular speed from the received data.

The model for determining the instantaneous angular speed Ω(t) can include explicit equations based on the fundamental principle of dynamics.

In particular, in the method 400 according to the invention, due to the particular design of the forcing step 410, the position x of the mass M along the direction x of the pilot mode as a function of the date t has the form x(t)=xₘₐₓ cos (ωt) and the position y of the mass M along the direction y of the detection mode as a function of the date t has the form y(t)=yₘₐₓ sin (ωt).

The trajectory of the mass M is thus an ellipse in the coordinate frame xyZ, unlike the methods of the prior art, for which the trajectory of the mass M is a straight line segment of direction x.

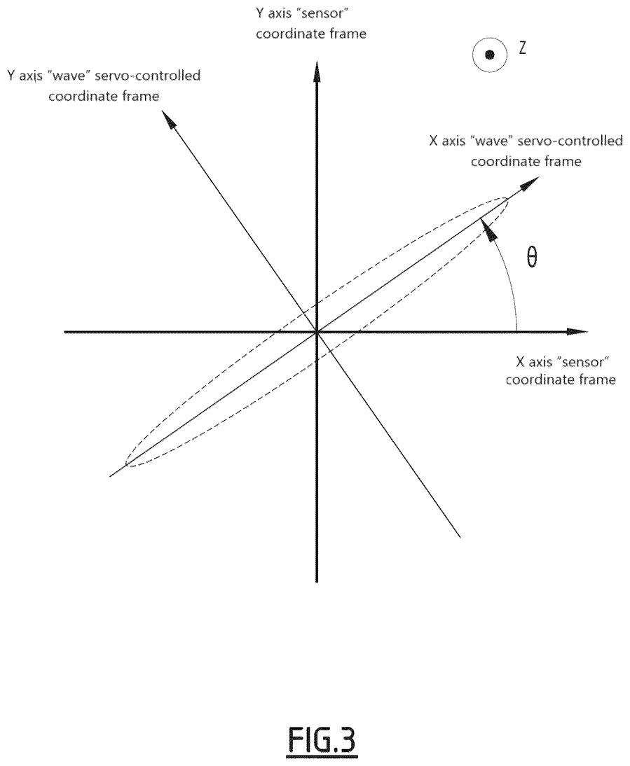

If the direction x of the pilot mode with respect to the axis X of the coordinate frame XYZ attached to the housing 12 is identified by the angle θ shown in FIG. 3, the coordinates X and Y of the mass m in the coordinate frame XYZ attached to the housing 12 are related to the coordinates x and y of the mass M in the coordinate frame xyZ by equation 1:

$$[ \begin{matrix}X \\ Y\end{matrix} ] = [ \begin{matrix}cos θ & - sin θ \\ sin θ & cos θ\end{matrix} ] [ \begin{matrix}x \\ y\end{matrix} ] = R ( θ ) [ \begin{matrix}x \\ y\end{matrix} ] \qquad [ Math 1 ]$$

$$with$$

$$R ( θ ) = [ \begin{matrix}cos θ & - sin θ \\ sin θ & cos θ\end{matrix} ] \qquad [ Math 2 ]$$

The first time derivatives dX/dt and dY/dt of the coordinates X and Y of the mass M thus satisfy:

$$[ \begin{matrix}\dot{X} \\ \dot{Y}\end{matrix} ] = R ( θ ) [ \begin{matrix}\dot{x} - \dot{θ} y \\ \dot{θ} x + \dot{y}\end{matrix} ] \qquad [ Math 3 ]$$

The second time derivatives d²X/dt² and d²Y/dt² of the X and Y coordinates of mass M satisfy:

$$[ \begin{matrix}\ddot{X} \\ \ddot{Y}\end{matrix} ] = R ( θ ) [ \begin{matrix}\ddot{x} - {\dot{θ}}^{2} x - 2 \dot{θ} \dot{y} - \ddot{θ} y \\ 2 \dot{θ} \dot{x} + \ddot{θ} x + \ddot{y} - {\dot{θ}}^{2} y\end{matrix} ] \qquad [ Math 4 ]$$

In the forced sinusoidal regime at the angular frequency ω, if we neglect the terms that are not proportional to a positive integer power of the angular frequency ω in front of the other terms, equation 4 can be written in the simplified form of equation 5:

$$[ \begin{matrix}\ddot{X} \\ \ddot{Y}\end{matrix} ] = R ( θ ) [ \begin{matrix}\ddot{x} - 2 \dot{θ} \dot{y} \\ 2 \dot{θ} \dot{x} + \ddot{y}\end{matrix} ] \qquad [ Math 5 ]$$

In the frame of reference of the housing 12, the mass M is subjected, during the forcing step 410, to the first force F_{x,amp}, to the second force Fₓ, to the third force F_{y,amp}, to the fourth force F_{y}, to the restoring forces of the springs, and to a damping that is modeled by a fluid friction force along each of the directions x and y associated with a quality factor Q.

The damping matrix A of the vibrating element 15, taking into account damping anisotropies, has the form described in equation 6:

$$A = \frac{M {ω}_{0}}{Q} \cdot [ \begin{matrix}1 & 0 \\ 0 & 1\end{matrix} ] + [ \begin{matrix}a 1 & a 2 \\ a 2 & - a 1\end{matrix} ] \qquad [ Math 6 ]$$

The stiffness matrix K1 of the vibrating element 15, taking into account stiffness anisotropies, has the form:

$${K}_{1} = K \cdot [ \begin{matrix}1 & 0 \\ 0 & 1\end{matrix} ] + [ \begin{matrix}r 1 & r 2 \\ r 2 & - r 1\end{matrix} ] = M {ω}_{0}^{2} [ \begin{matrix}1 & 0 \\ 0 & 1\end{matrix} ] + [ \begin{matrix}r 1 & r 2 \\ r 2 & - r 1\end{matrix} ] \qquad [ Math 7 ]$$

Moreover, when the frame of reference of the housing 12 is driven by a rotational movement of the component of Ω(t) along the direction Z with respect to the inertial frame of reference, the mass M, due to the non-zero relative speed thereof in the coordinate frame the housing 12, is subjected to a Coriolis inertial force in the coordinate frame of the housing 12.

Newton's second law applied to the mass M in the non-Galilean frame of reference the housing leads to equation 8:

$$[ Math 8 ]$$

$$M [ \begin{matrix}\ddot{X} \\ \ddot{Y}\end{matrix} ] + {K}_{1} [ \begin{matrix}X \\ Y\end{matrix} ] + A [ \begin{matrix}\dot{X} \\ \dot{Y}\end{matrix} ] + 2 Ω [ \begin{matrix}0 & - M \\ M & 0\end{matrix} ] [ \begin{matrix}\dot{X} \\ \dot{Y}\end{matrix} ] [ \begin{matrix}{F}_{tot , X} \\ {F}_{tot , Y}\end{matrix} ] = R ( θ ) [ \begin{matrix}{F}_{tot , x} \\ {F}_{tot , y}\end{matrix} ] = R ( θ ) [ \begin{matrix}{F}_{x} + {F}_{x , amp} \\ {F}_{y} + {F}_{y , amp}\end{matrix} ]$$

i.e., after multiplying by R(−θ) and with the approximations of equation 5:

$$[ Math 9 ]$$

$$M [ \begin{matrix}\ddot{x} - 2 \dot{θ} \dot{y} \\ 2 \dot{θ} \dot{x} + \ddot{y}\end{matrix} ] + K [ \begin{matrix}X \\ Y\end{matrix} ] + R ( - θ ) [ \begin{matrix}r 1 & r 2 \\ r 2 & - r 1\end{matrix} ] R ( θ ) [ \begin{matrix}x \\ y\end{matrix} ] + R ( - θ ) ( \frac{M {ω}_{0}}{Q} \cdot Id + [ \begin{matrix}a 1 & a 2 \\ a 2 & - a 1\end{matrix} ] R ( θ ) [ \begin{matrix}\dot{x} \\ \dot{y}\end{matrix} ] + 2 Ω R ( - θ ) [ \begin{matrix}0 & - M \\ M & 0\end{matrix} ] R ( θ ) [ \begin{matrix}\dot{x} \\ \dot{y}\end{matrix} ] = [ \begin{matrix}{F}_{x} + {F}_{x , amp} \\ {F}_{y} + {F}_{y , amp}\end{matrix} ]$$

the left member of the equation shows a damping anisotropy term of the form:

$$R ( - θ ) ( \frac{M {ω}_{0}}{Q} \cdot Id + [ \begin{matrix}a 1 & a 2 \\ a 2 & - a 1\end{matrix} ] ) R ( θ ) [ \begin{matrix}\dot{x} \\ \dot{y}\end{matrix} ] \qquad [ Math 10 ]$$

the component aₓ of which along the direction of the pilot mode x is:

$$[ Math 11 ]$$

$${a}_{x} = ( \frac{M {ω}_{0}}{Q} + a 1 cos ( 2 θ ) + a 2 sin ( 2 θ ) ) \dot{x} + ( a 2 cos ( 2 θ ) - a 1 sin ( 2 θ ) ) \dot{y} = {α}_{1 , x} \dot{x} + {α}_{2 , x} \dot{y}$$

and the component ay of which, along the direction of the detection mode y is:

$$[ Math 12 ]$$

$${a}_{y} = ( a 2 cos ( 2 θ ) - a 1 sin ( 2 θ ) ) \dot{x} + ( \frac{M {ω}_{0}}{Q} - a 1 cos ( 2 θ ) - a 2 sin ( 2 θ ) ) \dot{y} = {α}_{1 , y} \dot{x} + {α}_{2 , y} \dot{y} = {α}_{2 , x} \dot{x} - {α}_{1 , x} \dot{y}$$

The first term α_{1,x}dx/dt of the component aₓ of the damping anisotropy term, i.e. the term proportional to dx/dt, is compensated by means of the first force F_{x,amp}. Same is therefore compensated in the reference example by means of the first amplitude control of the first servo module 20.

The second term α_{2,x}dy/dt of the component aₓ of the damping anisotropy term, which is proportional to dy/dt, is compensated by means of the second force Fₓ. Same is thus compensated in the reference example by means of the stiffness control of the first servo module 20.

The first force F_{x,amp} thus has as expression

$${F}_{x , a m p} = ( \frac{M {ω}_{0}}{Q} + a 1 cos ( 2 θ ) + a 2 sin ( 2 θ ) ) \dot{x} \qquad [ Math 13 ]$$

The second term α_{2,y}dy/dt of the component ay of the damping anisotropy term, i.e. the term proportional to dy/dt, is observable precisely because the amplitude of vibrations along the direction of the detection mode is set at a non-zero value yₘₐₓ.

Same is compensated by means of the third force F_{y,amp}, hence in the example described hereinabove by means of the second amplitude control of the second servo module 25.

The third force F_{y,amp} thus has the form:

$${F}_{y , amp} = ( \frac{M {ω}_{0}}{Q} - a 1 cos ( 2 θ ) - a 2 sin ( 2 θ ) ) \dot{y} \qquad [ Math 14 ]$$

It can be seen that the third force F_{y,amp} is proportional to dy/dt and thus exists only because the movement of the vibrating element in the coordinate frame xyZ is elliptical and not rectilinear. The third force F_{y,amp} is quite different from the force used in the prior art for the servoing of the amplitude of the vibrations in the direction y, to a zero value.

It can also be seen that the amplitudes F_{x,amp,max} and F_{y,amp,max} of the first and third forces satisfy:

$$a 1 cos ( 2 θ ) + a 2 sin ( 2 θ ) = \frac{1}{2 {ω}_{0}} ( \frac{{F}_{x , amp ,}}{{x}_{max}} - \frac{{F}_{y , amp , max}}{{y}_{max}} ) \qquad [ Math 15 ]$$

The servoing of the amplitudes of the vibrations to a non-zero value not only along the direction x but also along the direction y makes it possible to determine the anisotropy matrix.

The coefficients a1 and a2 can be deduced from equation 15 as soon as measurements are available for a plurality of different angles θ.

Such a determination is not possible in a gyroscope of the prior art, for which only equation 13 is available, the terms of equation 14 being zero. Indeed, the term Mω₀/Q is strongly dependent on the temperature of the vibrating element 15 so that it is not possible to deduce a1 and a2 from equation 13 alone.

In the reference example, the processor common to the first servo module 20 and to the second servo module 25 thus determines the first force F_{x,amp} and the third force F_{y,amp} which are effectively exerted by the servo modules 20 and 25 to obtain the desired amplitude servoing along the directions x and y. The processor deduces therefrom the expression of coefficients a1 and a2 of the anisotropy matrix.

In the end, if the harmonic errors related to the anisotropies of stiffness (corresponding to the terms r1 and r2) are neglected, and with the approximations made for equation 5, Newton's second law applied to the mass in the non-Galilean frame of reference attached to the housing 12 makes it possible, after simplifying by means of equations 13 and 14 and grouping together the terms in phase with the vibrations along the direction x and the terms in phase quadrature with the vibrations, to write the following two equations 16 and 17:

$$[ Math 16 ]$$

$$\frac{{F}_{x , max}}{M} = {x}_{max} ( {ω}_{0}^{2} - {ω}^{2} ) - 2 \dot{θ} {y}_{max} ω - 2 Ω ω {y}_{max} + ( a 2 cos ( 2 θ ) - a 1 sin ( 2 θ ) ) ω {y}_{max}$$

wherein F_{x,max} is the first amplitude, i.e. the amplitude of the second force Fₓ to be supplied to the first servo module 20, and

$$[ Math 17 ]$$

$$\frac{{F}_{y , max}}{M} = {y}_{max} ( {ω}_{0}^{2} - {ω}^{2} ) - 2 \dot{θ} {x}_{max} ω - 2 Ωω {x}_{max} - ( a 2 cos ( 2 θ ) - a 1 sin ( 2 θ ) ) ω {x}_{max}$$

where F_{y,max} is the second amplitude, i.e. the amplitude of the fourth force F_{y} to be supplied to the second servo module 25.

In methods of the prior art, the excitation angular frequency ω is approximately equal to the natural angular frequency ω₀ and yₘₐₓ=0.

On the other hand, in the method 400 according to the invention, the amplitude yₘₐₓ is fixed and equal to a predetermined non-zero value, as is the amplitude xₘₐₓ.

Moreover, it has been seen that the coefficients of the anisotropy matrix are determined accurately from the third force F_{y,amp}.

Such coefficients make it possible to correct in real time the anisotropy defects appearing in equations 16 and 17, so that in the end, the second and fourth forces have the expression, after correction in real time by the servo modules 20, 25 of the anisotropy defects made accessible:

$$\frac{{F}_{x , max}}{M} = {x}_{max} ( {ω}_{0}^{2} - {ω}^{2} ) - 2 \dot{θ} {y}_{max} ω - 2 Ω ω {y}_{max} \qquad [ Math 18 ]$$

$$\frac{{F}_{y , max}}{M} = {y}_{max} ( {ω}_{0}^{2} - {ω}^{2} ) - 2 \dot{θ} {x}_{max} ω - 2 Ω ω {x}_{max} \qquad [ Math 19 ]$$

Anisotropy errors are thus known and managed in method 400, unlike the methods of the prior art.

In the method 400 according to the invention, it is understood from equations 18 and 19 that the angle θ which characterizes the direction x in the coordinate frame XY is not constant due to the application of the second force and the fourth force and that, with the approximations that have been made, said angle satisfies equation 20:

$$\dot{θ} = - Ω + \frac{1}{4 {x}_{max}^{2} - 4 {y}_{max}^{2}} ( 2 {y}_{max} \frac{{F}_{x , max}}{M {ω}_{0}} - 2 {x}_{max} \frac{{F}_{y , max}}{M {ω}_{0}} ) \qquad [ Math 20 ]$$

The direction x of the pilot mode and the direction y of the detection mode will thus vary over time in the frame of reference XYZ of the housing 12 because of the second and fourth forces applied simultaneously along said two directions.

During the determination step 420, the determination module 35 can deduce the instantaneous angular speed Ω(t) of the sensor with respect to the axis Z from the data same receives from the measurement module 30, which make it possible to determine dθ/dt, the first amplitude F_{x,max}, the second amplitude F_{y,max}, as well as the amplitudes xₘₐₓ and yₘₐₓ and the following equation 21:

$$Ω ( t ) = - \dot{θ} + \frac{1}{4 {x}_{max}^{2} - 4 {y}_{max}^{2}} ( 2 {y}_{max} \frac{{F}_{x , max}}{M {ω}_{0}} - 2 {x}_{max} \frac{{F}_{y , max}}{M {ω}_{0}} ) \qquad [ Math 21 ]$$

It should also be noted that the measurement data provided by the measurement module 30 also enable the determination module 35 to estimate the angular frequency ω of the vibrations of the vibrating element 15.

As mentioned hereinabove, the angular frequency ω is close to the natural angular frequency ω₀ of the vibrating element, and thus is an estimator of the natural angular frequency, which can be injected into equation 21 to determine the instantaneous angular speed Ω(t).

Equations 18 and 19 make it possible to form the following equation 22 on the angular frequency ω:

$$ω = {ω}_{0} + \frac{1}{4 {x}_{max}^{2} - 4 {y}_{max}^{2}} ( - 2 {x}_{max} \frac{{F}_{x , max}}{M {ω}_{0}} + 2 {y}_{max} \frac{{F}_{y , max}}{M {ω}_{0}} ) \approx {ω}_{0} \qquad [ Math 22 ]$$

Furthermore, it should be noted that it is possible to adjust one and/or the other of the predetermined amplitudes F_{x,max} and F_{y,max} to increase or reduce the angular frequency slip with respect to the natural angular frequency ω₀.

Advantageously, the relative difference between the angular frequency ω and the natural angular frequency ω₀ is less than 10%, preferably on the order of 1% or less.

Typically, the natural angular frequency can be on the order of 10 Hz. The relative difference between the angular frequency ω and the natural angular frequency ω₀ can then be less than 1 Hz, and in particular be typically on the order of one tenth of a Hz.

Insofar as the implementation of vibrations of non-zero amplitude according to the detection mode is likely to bring in errors in the measurement of the angular speed Ω(t), it is advantageous to make a compromise between the anisotropy management permitted by the non-zero detection amplitude yₘₐₓ and the new errors.

Advantageously, the ratio between the pilot amplitude xₘₐₓ and the detection amplitude yₘₐₓ is less than 10, or even less than 100.

Advantageously, the detection amplitude yₘₐₓ is on the order of 1/100^{th}, or even on the order of 1/1000^{th} of the pilot amplitude xₘₐₓ.

1. A gyroscopic measurement method by means of a sensor comprising a housing and a vibrating element apt to vibrate relative to the housing in a vibration plane simultaneously along a direction of a pilot mode and along a direction of a detection mode different from the direction of the pilot mode, the method comprising:
the supply to a first servo module of the sensor:
a) of a first amplitude of a first force to be exerted along the direction of the pilot mode on the vibrating element, and
b) of a predetermined non-zero pilot amplitude to which an amplitude characteristic of forced sinusoidal vibrations of the vibrating element along the direction of the pilot mode is to be servoed; and
simultaneously, the application of the first force on the vibrating element and the servoing of the amplitude characteristic of the forced sinusoidal vibrations of the vibrating element along the direction of the pilot mode by means of the first servo module receiving measurements of the vibrations of the element vibrating along the direction of the pilot mode from a measurement module measuring the vibrations of the vibrating element;
the method being characterized in that the method further comprises:
the supply to a second servo module:
c) of a second amplitude of a second force to be exerted in phase quadrature with the first force along the direction of the detection mode, and
d) of a predetermined non-zero detection amplitude to which an amplitude characteristic of the vibrations of the vibrating element along the direction of the detection mode is to be servoed; and
simultaneously, the application of the second force on the vibrating element and the servoing of the characteristic amplitude of the vibrations of the vibrating element along the direction of the detection mode by means of the second servo module receiving measurements of a position of the vibrating element along the direction of the detection mode from the measurement module; and
the determination, by means of a sensor determination module, of an instantaneous angular speed of the housing in an inertial frame of reference from the first and second amplitudes of the first and second forces, from the non-zero pilot amplitude and the detection amplitude, as well as from the measurements of the vibrations of the vibrating element transmitted by the measurement module to the first and second servo modules.

2. The method according to claim 1, wherein the ratio between the pilot amplitude and the detection amplitude is less than 100.

3. The method according to claim 1, wherein the vibrations of the vibrating element are characterized by an angular frequency different from the natural angular frequency of the vibrating element, the relative difference between the angular frequency and the natural angular frequency being less than 10%.

4. The method according to claim 1, further comprising a step of determining an angular frequency characteristic of the vibrations of the vibrating element by means of the determination module, based on the measurements of the positions of the vibrating element transmitted by the measurement module to the first and second servo modules.

5. The method according to claim 1, wherein the application of the first force and of the second force on the vibrating element comprises a step of determining a matrix characteristic of an anisotropy of the vibrating element from an amplitude of a third force and from an amplitude of a fourth force actually exerted by the first servo module and the second servo module, respectively, to servo the characteristic amplitude of the vibrations of the vibrating element along the direction of the pilot mode and the characteristic amplitude of the vibrations of the vibrating element along the direction of the detection mode, respectively.

6. A gyroscopic sensor comprising:
a housing;
a vibrating element apt to vibrate relative to the housing along a vibration plane simultaneously along a direction of a pilot mode and along a direction of a detection mode different from the direction of the pilot mode;
a measurement module apt to generate measurements of the vibrations of the vibrating element along the directions of the pilot mode and of the detection mode;
a first servo module apt to:
i) exert a first force, the amplitude of which is equal to a predetermined first amplitude, on the vibrating element along the direction of the pilot mode,
ii) simultaneously servo a characteristic amplitude of the vibrations of the vibrating element in forced sinusoidal mode along the direction of the pilot mode to a predetermined non-zero pilot amplitude,
iii) receive measurements of the vibrations of the vibrating element along the direction of the pilot mode from the measurement module to carry out the servoing;
the sensor being characterized in that same comprises:
a second servo module apt to:
iv) exert a second force, the amplitude of which is equal to a predetermined second amplitude, on the vibrating element along the direction of the detection mode, the second force being in phase quadrature with the first force,
v) simultaneously servo a characteristic amplitude of the vibrations of the vibrating element along the direction of the detection mode to a non-zero detection amplitude,
vi) receive measurements of the vibrations of the vibrating element along the direction of the detection mode from the measurement module to carry out the servoing; and
a determination module apt to determine an instantaneous angular speed of the housing in an inertial frame of reference from the amplitudes of the first force and of the second force, from the non-zero pilot amplitude and the non-zero detection amplitude, as well as from the measurements of the vibrations of the vibrating element transmitted by the measurement module to the first and second servo modules.

7. A computer program comprising instructions that lead a gyroscopic sensor comprising:
a housing;
a vibrating element apt to vibrate relative to the housing along a vibration plane simultaneously along a direction of a pilot mode and along a direction of a detection mode different from the direction of the pilot mode:
a measurement module apt to generate measurements of the vibrations of the vibrating element along the directions of the pilot mode and of the detection mode:
a first servo module apt to:
i) exert a first force, the amplitude of which is equal to a predetermined first amplitude, on the vibrating element along the direction of the pilot mode,
ii) simultaneously servo a characteristic amplitude of the vibrations of the vibrating element in forced sinusoidal mode along the direction of the pilot mode to a predetermined non-zero pilot amplitude,
iii) receive measurements of the vibrations of the vibrating element along the direction of the pilot mode from the measurement module to carry out the servoing;
the sensor being characterized in that same comprises:
a second servo module apt to:
iv) exert a second force, the amplitude of which is equal to a predetermined second amplitude, on the vibrating element along the direction of the detection mode, the second force being in phase quadrature with the first force,
v) simultaneously servo a characteristic amplitude of the vibrations of the vibrating element along the direction of the detection mode to a non-zero detection amplitude,
vi) receive measurements of the vibrations of the vibrating element along the direction of the detection mode from the measurement module to carry out the servoing; and
a determination module apt to determine an instantaneous angular speed of the housing in an inertial frame of reference from the amplitudes of the first force and of the second force, from the non-zero pilot amplitude and the non-zero detection amplitude, as well as from the measurements of the vibrations of the vibrating element transmitted by the measurement module to the first and second servo modules to execute the determination step for determining the instantaneous angular speed of the housing of the method according to claim 1.
